(19) United States
(12) Patent Application Publication
(10) Pub. No.: US 2008/0041495 A1
(43) Pub. Date: Feb. 21, 2008

(54) Tenon cutting router bit

(76) Inventor: George Vondriska, Hudson, WI (US)

Correspondence Address: FROMMER LAWRENCE & HAUG, 745 FIFTH AVENUE- 10TH FL., NEW YORK, NY, 10151, US

(21) Appl. No.: 11/506,955

(22) Filed: Aug. 18, 2006

(51) Int. Cl. B27C 5/10; B23C 1/20; B27M 1/08; B27C 9/00; B27M 1/00

(52) U.S. Cl. 144/371; 144/136.95; 409/182

(57) ABSTRACT

A router bit that includes an arbor having a shank portion, a shaft portion and a collar section intermediate the shank portion and shaft portion. The router bit also includes at least one lower cutter having a body portion and at least two cutter blades and at least one upper cutter having a body portion and at least two cutter blades. Disposed between and defining a distance between the at least one lower cutter and the at least one upper cutter is at least one spacing element. The distance between the at least one lower cutter and the at least one upper cutter is adjustable by varying the number of spacing elements.

### BACKGROUND OF THE INVENTION

1. Field of the Invention

The instant invention relates generally to router bits. More particularly, the instant invention relates to a router bit having at least two variably-spaced cutter elements that can be used to cut tenons for a mortise and tenon joinery.

2. Background of the Invention

Many woodworkers are frustrated by the fussy nature of accurately producing tenons for mortise and tenon joinery. The fit must be perfect to achieve the full strength benefit that mortise and tenon joints can offer.

A common solution is to set up a dado head in the tablesaw or straight bit in a router table. In order to create the tenon, both faces of the work piece are passed over the cutter (dado head or straight bit) to create the tenon faces. There are several problems inherent in this technique. In both instances, the height of the cutter must be set accurately so that equal material can be removed from each face of the board or work piece, resulting in a perfectly sized tenon in the center of the work piece. This is a very exacting and time consuming set up. Another problem can arise from slight variations in material thickness, or variations in the down pressure exerted on the material as it is being passed over the cutter. The resulting tenon can easily be too thick or too thin.

An alternate technique is to use a tenon cutting jig on the tablesaw, passing the material vertically over a saw blade. When a single saw blade is used, this technique has the same problems described above because each face of the tenon is cut separately. In addition, set up of a tenon cutting jig is time consuming and tricky. Sometimes the two rim blades of a dado set are used with a spacer in between them. This cuts the entire tenon at one time, and with careful set up of the spacer, achieves a good fit most of the time. With this method, however, an additional cut must be made to produce the shoulders of the tenon.

Therefore, a need exists to provide an alternative to current methods used to cut tenons for mortise and tenon joinery. Furthermore, there is a need for a quicker, more accurate method for cutting tenons for mortise and tenon joinery that can be used repeatedly to cut precise tenons having the same thickness regardless in variation in the material thickness.

### SUMMARY OF THE INVENTION

It is therefore a principal object of the invention to provide a router bit that can be used to cut tenons in a work piece for use in mortise and tenon joinery.

It is a further object of the invention to provide a router bit that has variably-spaced lower and upper cutters that is capable of producing tenons of different thicknesses.

Yet another object of the invention is to provide an alternative to conventional methods that are used to produce tenons.

A still further object of the invention is to provide a router bit that can more accurately produce tenons having the same thickness regardless of variations in material thickness or pressure applied to the work piece.

A further object of the invention is to provide a router bit that can be easily set up to produce tenons.

These and other objects and advantages are provided by the instant invention. In this regard, the instant invention is directed to a router bit and a method for producing tenons. The instant router bit comprises an arbor having a shank portion, a shaft portion and a collar section that is despised between the shank and shaft portions. Disposed on the shaft portion is at least one lower cutter that has a body portion and at least two cutter blades. Preferably, the instant router bit includes two lower cutters. In addition, at least one upper cutter that has a body portion and at least two cutter blades is disposed on the shaft portion of the arbor. Preferably, the instant router bit includes two upper cutters. The spacing between the lower and upper cutters is variable so that tenons of different thicknesses can be cut using the instant router bit. Disposed between the lower and the upper cutters is at least one spacing element such as a spacer or shim. The distance between the lower and upper cutters can be adjusted by changing (adding or removing) the number of spacing elements disposed between the lower and upper cutters. The spacing between the lower and upper cutters determines the thickness of a tenon to be cut or produced.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated in the accompanying drawings in which corresponding components are identified by the same reference numerals.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is an exploded side elevation view or a router bit, according to one embodiment of the instant invention;

FIG. 2A is a perspective view of an assembled router bit, according to one embodiment of the instant invention;

FIG. 2B is a perspective view of an assembled router bit, according to one embodiment of the instant invention;

FIG. 3 is a top view of an assembled router bit, according to one embodiment of the instant invention;

FIG. 4 is an elevation view of a cutter, according to one embodiment of the instant invention;

FIG. 5 is a perspective view of a mortise and tenon joint where the tenon was cut according to one embodiment of the instant invention;

FIG. 6A is an elevation view of a router bit cutting a tenon, according to one embodiment of the instant invention;

FIG. 6B is an elevation view of a router bit cutting a tenon, according to one embodiment of the instant invention;

FIG. 6C is an elevation view of a router bit cutting a tenon, according to one embodiment of the instant invention; and

FIG. 6D is an elevation view of a router bit cutting a tenon, according to one embodiment of the instant invention.

### DETAILED DESCRIPTION OF THE PREFERRED EMBODIMENTS

The instant invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

Routers and router bits have long been used for cutting various profiles and configurations along the edges of work pieces composed of wood or other materials. These profiles and configuration include bevels, chamfers, roundovers, ogees, coves, etc. The instant invention relates to a router bit that is used to cut tenons in a work piece for use in mortise and tenon joinery. More specifically, the instant invention relates to a router bit that has variably spaced cutters that allow the distance between the cutters to be increased or decreased in order to change the thickness of a tenon that is being cut with the router bit.

In the following description, like reference characters designate like or corresponding parts throughout the figures. Additionally, in the following description, it is understood that terms such as “upper,” “lower,” and the like are words of convenience and are not to be construed as limiting terms.

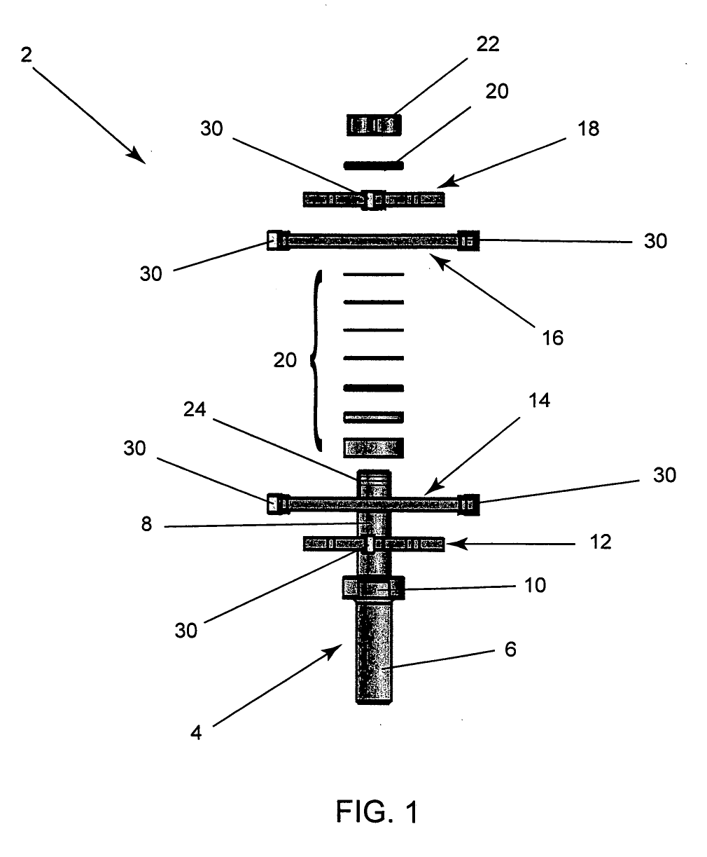

Referring now to the figures, FIG. 1 depicts an exploded view of a router bit 2 constructed in accordance with one embodiment of the instant invention. The router bit 2 comprises an arbor 4 having a shank portion 6 and a shaft portion 8 with an integral collar section 10 disposed between the shank portion 6 and the shaft portion 8. Preferably, the instant router bit 2 has a ½″ diameter shank portion 6 although additional diameters such a ¼″ may be used. According to one embodiment of the instant invention, disposed on the shaft portion 8 of the arbor 4 are first and second bottom cutters 12 and 14. Also disposed on the shaft portion 8 of the arbor 4 are first and second upper cutters 16 and 18. As can further be seen in FIG. 1, intermediate the lower cutters, 12 and 14, and the upper cutters, 16 and 18, are an array of spacing elements 20 which may comprise spacers and shims ranging in thickness from 0.1 mm to ¼″. As will be apparent to those skilled in the art and as will be discussed below, the number of spaces and shims 20 can vary from one to a plurality of spacers and shims 20 depending on the desired thickness of the tenon being cut. Lastly, in order to secure the cutters and the spacers to the arbor and to maintain each element in a rotationally-fixed position relative to one another, a washer 20 is disposed on the shaft portion 8 on top of the upper most upper cutter 18 and a nut 22 threadingly engages the threaded portion 24 on the end of the shaft portion 8 of the arbor 4. With the cutters and spacers securely mounted on the arbor 4, all of the components that comprise the router bit 2 rotate as a single structure when used in a router.

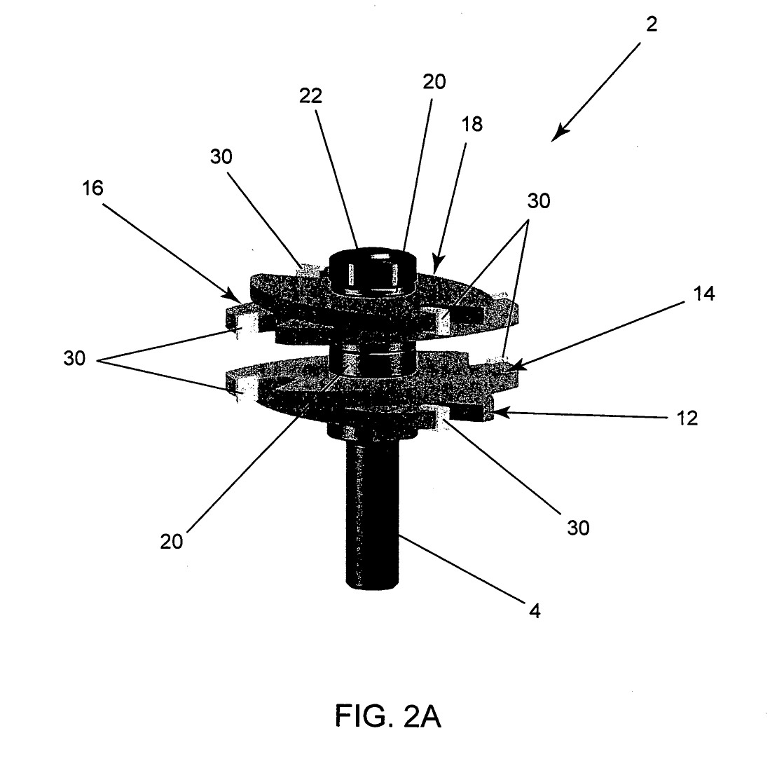

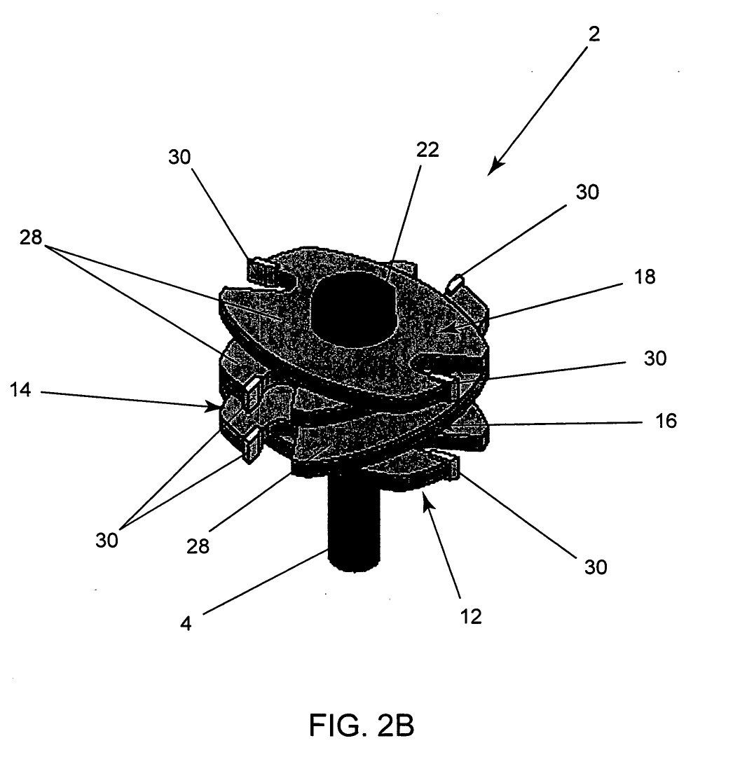

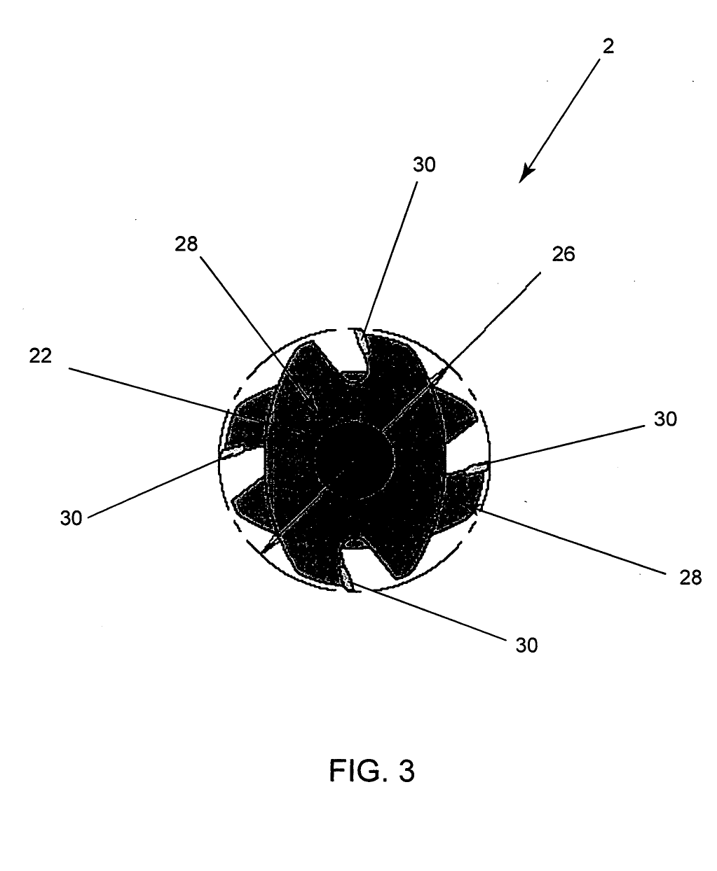

FIGS. 2A and 2B depict an assembled router bit 2 according to one embodiment of the instant invention. As can be seen in the figures, the lower and upper cutters, 12 and 14, and 16 and 18, respectively, are disposed on the arbor 4 with a plurality of spacing elements 20 (spacers and shims) positioned therebetween with the washer 20 and nut 22 threadingly engaged with the threaded portion 24 of the shaft portion 8 of the arbor 4. Furthermore, as can be seen in FIGS. 2A, 2B and 3, the lower and upper cutters are elliptically-shaped and each cutter in the pair of lower and upper cutters are disposed at 90° to each other. That is, each cutter in the pair is 90° out of phase with each other and each cutter is fixed in relation to the others by the clamping pressure applied by the nut 22. The diameter of the circle 26 formed by the cutters as the router bit 2 rotates is 2 61/64″. Therefore, the maximum tenon length that can be cut with a router bit according to the instant embodiment is 1 1/16″.

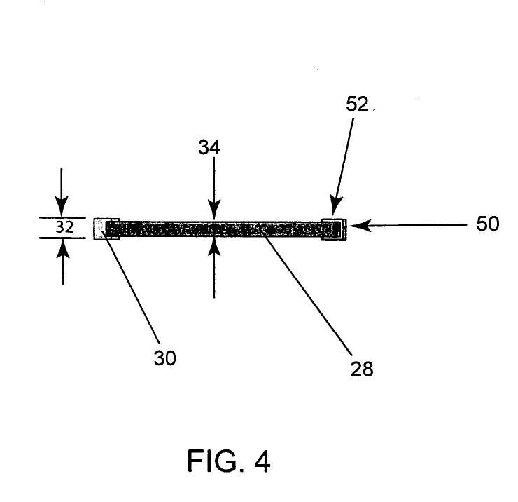

As depicted in the figures, each cutter comprises a body portion 28 and cutter blades 30. Preferably, one pair of diametrically opposed cutter blades 30 are secured to the body portion 28, however as will be apparent to those skilled in the art, any number of cutter blades 30 may be secured to the body portion 28. The cutter blades 30 are spaced about the circumference of the body portion 28 so as to assist in balancing the weight of the router bit 2 in all radial directions. As depicted in FIG. 4, the cutter blades 30 have edge portions 50 that extend in a substantially axial direction and edge portions 52 that extend in a substantially radial direction. The cutter blades 30 can be any thickness but as shown in FIG. 4, preferably, the cutter blades 30 have a thickness 32 that is thicker than the thickness 34 of the body portion 28. In the instant embodiment, the thickness of the cutter blades 30 is ¼″.

The body portion 28 and the arbor 4 may be manufactured from steel and the cutter blades 30 may be manufactured from carbide, high strength steel (HSS) or some other wear-resistant material. In order to increase the performance of the instant router bit, the exterior surface of the body portion 28 is coated with a friction-reducing material. The friction-reducing material may be, for example, a polymer having friction-reducing capabilities, such as, but not limited to fluorocarbon polymers. Preferred fluorocarbon polymers include tertrafluoroethylene (TFE) and polytetrafluoroethylene (PTFE) fluorocarbon polymers and fluorinated ethylene-propylene (FEP) polymers. In the instant embodiment of the invention, the PTFE coating is an orange PTFE coating. Because the PTFE coating reduces friction, the router bit performs better, lasts longer and cleans up quicker.

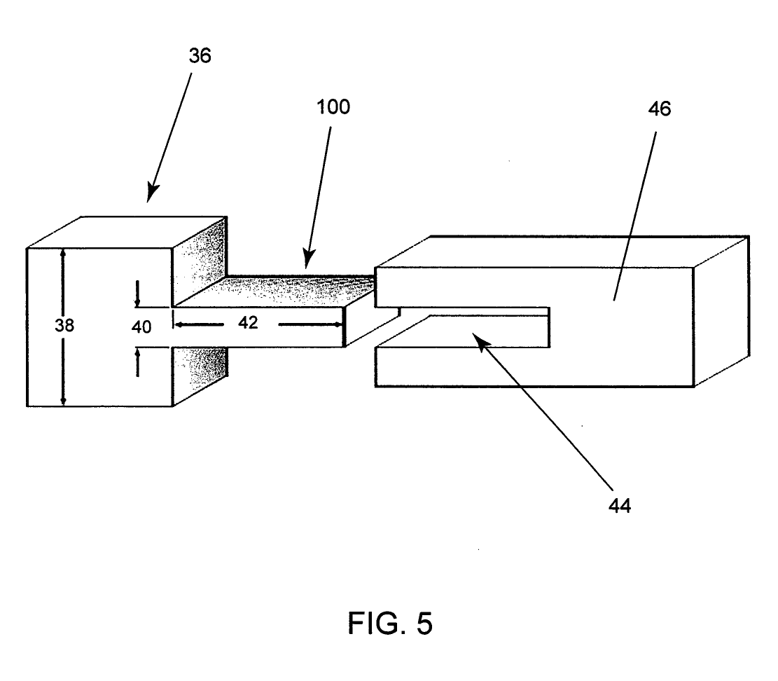

As described below and as depicted in FIG. 5, a work piece 36 having a maximum thickness of 1⅜″, depicted by double-arrow 38, can be routed with the instant router bit to produce a tenon 100 having a minimum thickness of 3/16″ and a maximum thickness of ⅜″, depicted by double arrow 40, and a maximum length of 1 1/16″ depicted by double arrow 42, to engage a mortise 44 in a corresponding work piece 46.

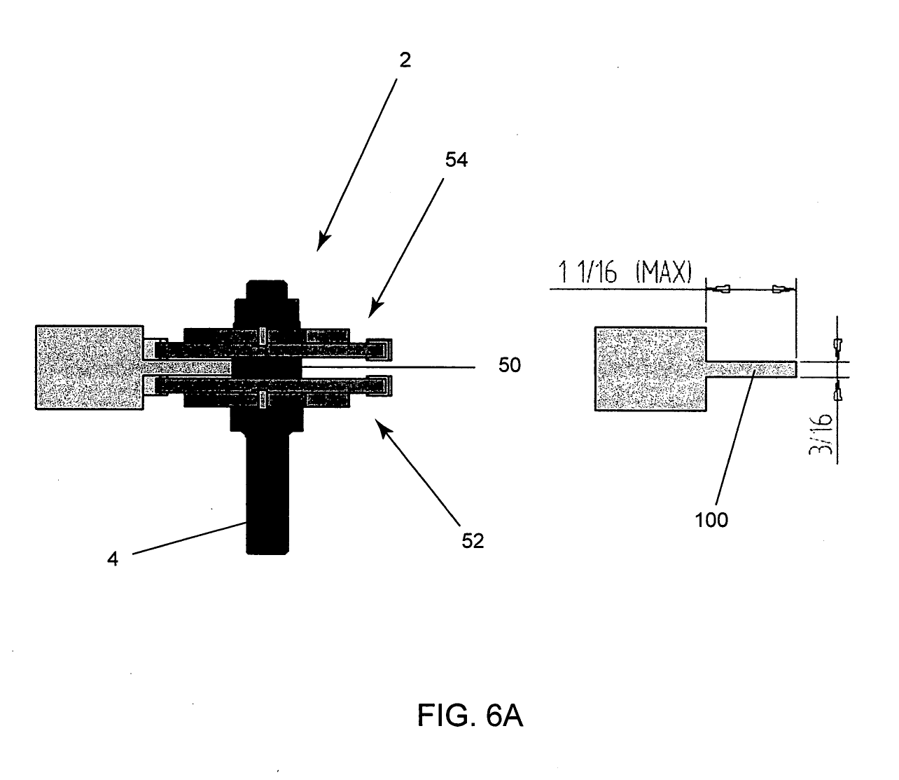

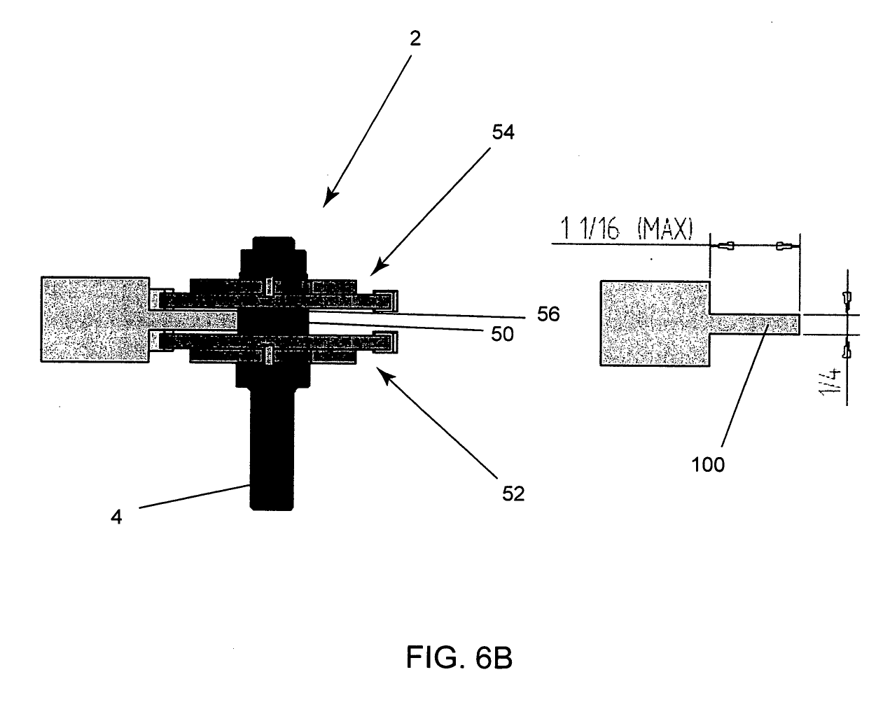

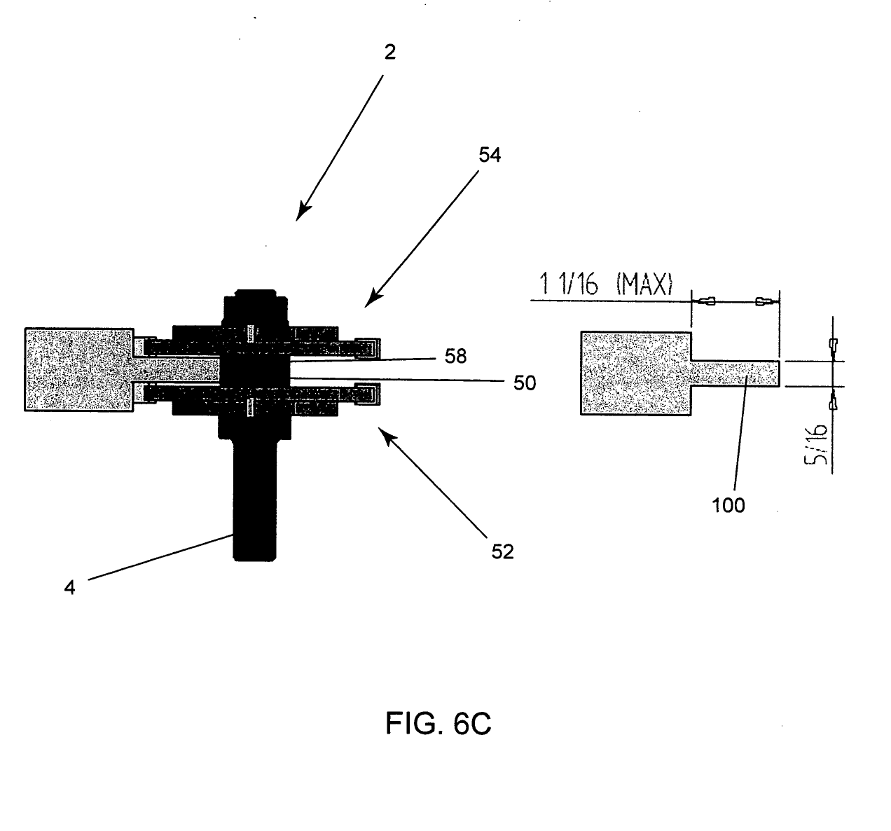

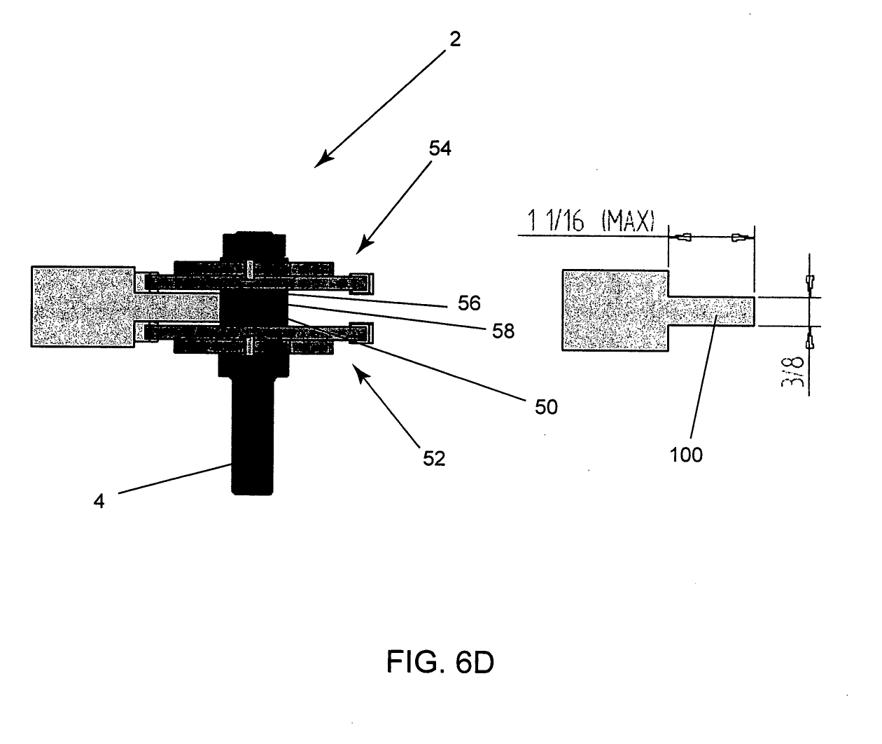

Turning now to the set up and use of a router bit according to the instant invention, once a user determines the thickness of a tenon to be cut, the user chooses the required combination of spacers and shims to be disposed between the lower and upper cutters. For example, as depicted in FIG. 6A, to produce a tenon 100 having a thickness of 3/16″, a user would place a single ¼″ spacer 50 between the paired lower and upper cutters, 52 and 54, respectively. To produce a tenon 100 having a thickness of ¼″, as depicted in FIG. 6B, a user would place a ¼″ spacer 50 and a 1/16″ spacer 56 between the paired lower and upper cutters, 52 and 54, respectively. To produce a tenon 100 having a thickness of 5/16″, as depicted in FIG. 6C, a user would place a ¼″ spacer 50 and a ⅛″ spacer 58 between the paired lower and upper cutters, 52 and 54, respectively. Lastly, to produce a tenon 100 having a thickness of ⅜″, as depicted in FIG. 6D, a user would place a ¼″ spacer 50, a ⅛″ spacer 58 and a 1/16″ spacer 56 between the paired lower and upper cutters, 52 and 54, respectively.

After the router bit 2 is assembled with the lower and upper cutters, 52 and 54 respectively, and the desired number of spacers and shims, a user secures all of the elements in position on the arbor by threadingly engaging the nut 22 with the threaded shaft portion of the arbor 4. Once the nut 22 is tightened down, thereby securing all elements in a rotationally-fixed position on the shaft portion 8 so that all of the elements rotate as a single structure, the router bit 2 is placed in a table-mounted router and is now ready for user. In addition to assembling the instant router bit prior to placement in a router, the bit may first be placed in a router and then assembled while in the router following the previously disclosed assembly steps. If after the user performs test cuts on the material and the lower cutters to upper cutters spacing is not set to produce the exact tenon thickness desired, shims varying in thickness from 0.1 mm to 0.3 mm may be added to the router bit between the lower and upper cutters to obtain the desired tenon thickness. Once the desired tenon thickness is obtained, bit setup is complete. Advantageously, once the instant router bit is set to produce tenons of the desired thickness, all tenons cut using the same set up will have the exact same tenon thickness regardless of variations in the material thickness or down pressure applied to the work piece.

As will be apparent to those skilled in the art, in additional embodiments of the instant invention, the number of lower and upper cutters can be increased or decreased depending on the thickness of the material being cut. That is, a single lower and a single upper cutter may be used instead of a pair of lower and upper cutters or more than two lower and two upper cutters may be used. Furthermore, the number of lower cutters does not have to be the same as the number of upper cutters. If additional cutters are used, an arbor having a shaft portion with an increased length will be necessary.

Although a preferred embodiment of the present invention and modifications thereof have been described in detail herein, it is to be understood that this invention is not limited to this precise embodiment and modifications, and that other modifications and variations may be effected by one skilled in the art without departing from the spirit and scope of the invention as defined by the appended claims.

What is claimed is:

1. A router bit comprising:
an arbor having a shank portion, a shaft portion and a collar section intermediate the shank portion and shaft portion;
at least one lower cutter having a body portion and at least two cutter blades;
at least one upper cutter having a body portion and at least two cutter blades; and
at least one spacing element intermediate the at least one lower cutter and the at least one upper cutter that defines a distance between the at least one lower cutter and the at least one upper cutter;
wherein said distance is adjustable by varying the number of spacing elements.

2. The router bit as claimed in claim 1, wherein said router bit comprises two lower cutters and two upper cutters.

3. The router bit as claimed in claim 1, wherein said router bit comprises a plurality of spacing elements.

4. The router bit as claimed in claim 1, wherein said spacing elements have thicknesses ranging from 0.1 mm to ¼″.

5. The router bit as claimed in claim 1, wherein said shank portion is ½″ in diameter.

6. The router bit as claimed in claim 1, wherein the at least two cutter blades on the body portion of the at least one lower cutter and the at least one upper cutter are diametrically opposed.

7. The router bit as claimed in claim 1, wherein said arbor and said body portions of the at least one lower and upper cutters are steel.

8. The router bit as claimed in claim 1, wherein said cutter blades are carbide.

9. The router bit as claimed in claim 1, wherein said cutter blades are high-strength steel.

10. The router bit as claimed in claim 1, wherein said body portions of the at least one lower cutter and the at least one upper cutter further comprises a fluorocarbon polymer coating.

11. The router bit as claimed in claim 10, wherein said fluorocarbon polymer coating is a PTFE coating.

12. The router bit as claimed in claim 11, wherein said PTFE coating is orange.

13. The router bit as claimed in claim 1, wherein said at least one lower cutter, said at least one upper cutter and said at least one spacing element are rotationally fixed in relation to one another by a clamping force exerted by a nut that threadingly engages said shaft portion.

14. The router bit as claimed in claim 1, wherein tenons cut with said router bit range in thickness from 3/16″ to ⅜″.

15. A method of routing a tenon comprising the steps of:
providing a router bit having variably-spaced lower and upper cutters;
determining the desired thickness for the tenon to be cut;
adding spacer elements to the router bit between the variably-spaced lower and upper cutters in order to set the variably-spaced lower and upper cutters at a desired distance apart from one another;
inserting the router bit into a router; and
routing the end of a work piece to form the tenon.

16. The method as claimed in claim 15, wherein the desired distance between the variably-spaced lower and upper cutters corresponds to the thickness of the tenon.

17. A tenon cutting router bit comprising:
an arbor having a shank portion, a shaft portion and a collar section intermediate the shank portion and shaft portion;
a pair of lower cutters each having a body portion and at least two cutter blades;
a pair of upper cutters each having a body portion and at least two cutter blades; and
at least one spacing element intermediate the pair of lower cutters and the pair of upper cutters that defines a distance between the pair of lower cutters and the pair of upper cutters;
wherein said distance is adjustable by varying the number of spacing elements.

18. The router bit as claimed in claim 17, wherein said router bit comprises a plurality of spacing elements.
